(19) United States
(12) Patent Application Publication
(10) Pub. No.: US 2002/0084936 A1
(43) Pub. Date: Jul. 4, 2002

(54) Spring stopper detail

(76) Inventors: Ulf Palin, Ljustero (SE); Magnus Bjornberg, Ljustero (SE)

Correspondence Address: JACOBSON HOLMAN, 400 SEVENTH STREET, N.W., WASHINGTON, DC, 20004, US

(21) Appl. No.: 10/005,915

(22) Filed: Dec. 7, 2001

(30) Foreign Application Priority Data
Dec. 13, 2000 (SE) 0004608-6

(51) Int. Cl. H01Q 1/24

(52) U.S. Cl. 343/702

(57) ABSTRACT

The invention is related to stopper for an extendable antenna which is mountable in a communication device. The stopper has a fastening portion for attachment to the lower end of an antenna rod, and is adapted to resiliently engage a holder when the antenna is extended. The stopper includes a stopper element with a cavity, which at least partially encloses a resilient element. The resilient element or the stopper element may be electrically conductive and connecting the antenna core to the RF transceiver in the communication device. The resilient element may be comprised by a wire or stripe, bent in a U or J-formed shape. Advantageously, the stopper element is provided with an opening through which the resilient element is introduceable into the cavity.

### FIELD OF THE INVENTION

The present invention relates to a stopper with a resilient element according to the introductory portion of claim 1. It also relates to an antenna device including such a stopper, and a radio communication device including such an antenna device.

### BACKGROUND OF THE INVENTION

Extendable whip antennas are typically provided with a stopper at the lower end of the whip, which acts to prevent the whip antenna from being detached from the holder at the mobile communication device, when the antenna is extended. The stopper also often provides electrical connection between the RF-transceiver in the mobile communication device, and the antenna in its extended position. The stopper may also have further ther functionality, such as locking the antenna in its extended position, preventing it from unintentionally sliding into the mobile communication device.

Designing a stopper that serves one or several of the tasks mentioned, and perhaps other tasks as well, which may be manufactured in a cost effective way is not easy. Each additional manufacturing step and each additional element adds to the cost, and a large number of designs for minimising the cost while still achieving the properties set for the device have been suggested, with varying degrees of success. A stopper design which minimises the manufacturing cost and still achieves the object is therefore needed.

German utility model no. 298 11124.1 discloses an antenna device with a stopper. The stopper comprises an essentially cylindrical conductive element, which electrically connects the antenna to the RF-transceiver of a mobile communication device. The essentially cylindrical surface of the stopper may be

slightly convex or concave to lock in a holder element when the antenna is extended. The stopper is resiliently compressible in its radial direction in order to engage the holder, and the radial compressibility is enhanced by providing the stopper with one or more slots which extend axially. Manufacturing of the stopper requires several steps including machining such as turning and milling.

### SUMMARY OF THE INVENTION

A general object of the invention is to provide a stopper which solves one or several of the problems with the prior art, and other problems, such as the difficulties with minimizing the number of manufacturing steps and the number of components, and simplifying the assembly process, which gives a cost effective manufacturing of the device.

This object is attained with a stopper with the features of the characterizing portion of claim 1. Here a stopper for an extendable antenna is disclosed, which comprises a stopper element with a cavity, which cavity at least partially encloses a resilient element. This solution gives a stopper which is easily and cheaply manufactured and assembled. The resilient element is manufactured in a suitable substance, such as metal if the resilient element should be conductive, or plastic if conductivity is not necessary.

According to other aspects of the invention, the resilient element or the stopper element may be electrically conductive and connected to the antenna core. Thus the resilient element or the stopper element acts to connect the antenna core with a RF transceiver in the communication device.

According to further aspects of the invention, the resilient element may be comprised by a wire or stripe bent in a U or J-shape. Then a first end of the stopper cavity is arranged for receiving and resiliently fixing a first end of the resilient element, while second end of the stopper cavity is arranged for receiving a second end of the resilient element.

Advantageously, according to a further aspect of the invention, the stopper element is provided with an opening through which the resilient element may be introduced into the cavity. This facilitates mounting of the resilient element into the cavity.

Yet further advantages are obtained through the features of the other dependent claims.

### BRIEF DESCRIPTION OF THE DRAWINGS

FIG. 1 shows a first embodiment of the stopper, viewed from the front.

FIG. 2 shows the first embodiment of the stopper in cross section

FIG. 3 shows the first embodiment of the stopper, viewed from the side.

FIG. 4 shows a first embodiment of a resilient element.

FIG. 5 shows the first embodiment of the stopper in cross section, while the resilient element is being inserted.

FIG. 6 shows the first embodiment of the stopper, viewed from the side, while the resilient element is being inserted.

FIG. 7 shows a second embodiment of the stopper, viewed from the side.

FIG. 8 shows the second embodiment of the stopper in cross section, while the resilient element is being inserted.

FIG. 9 shows a third embodiment of the stopper in cross section.

### DESCRIPTION OF PREFERRED EMBODIMENTS

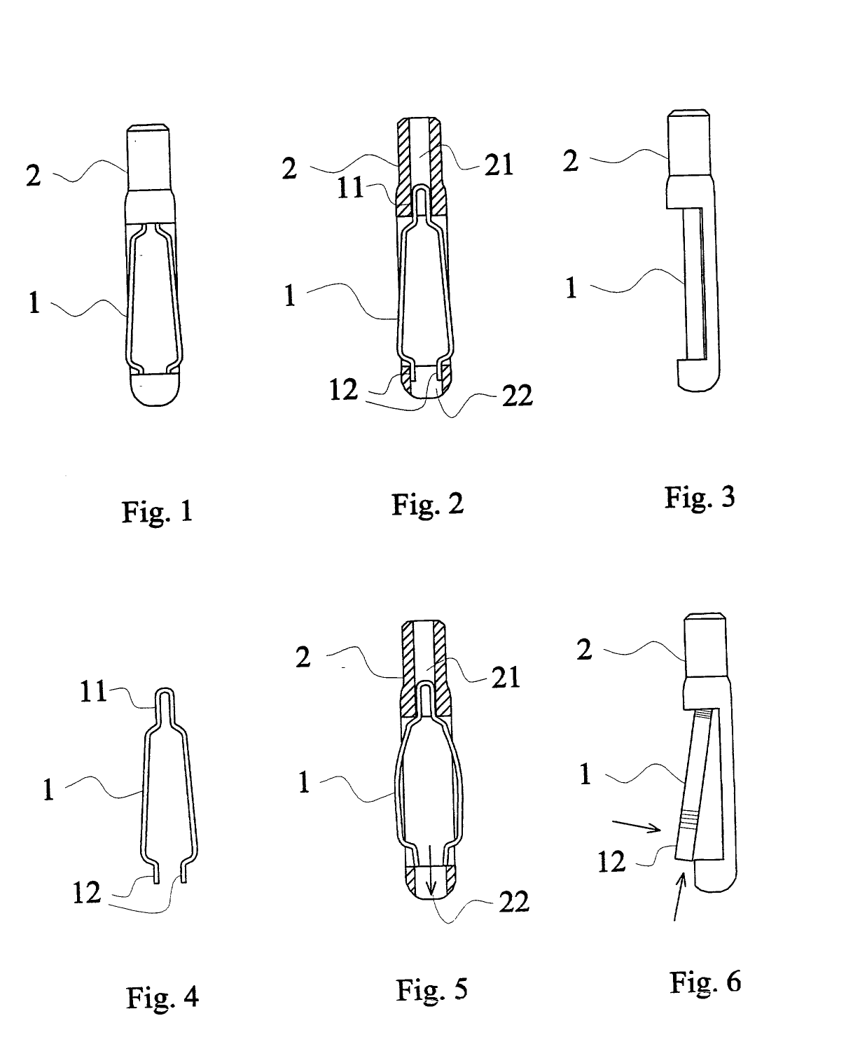

FIG. 1 shows a first embodiment of the stopper, viewed from the front. The stopper comprises an essentially cylindrical to stopper element 2, which at its upper end is attachable to an antenna whip (not shown). The stopper element 2 is wider at its lower portion than at its upper portion, and, when the antenna with the stopper is extended, engages a holder (not shown), which is correspondingly shaped to engage the stopper. Depending on the design of the holder, the wider lower portion of the stopper element, or the top of the upper portion of the stopper, prevents the antenna from being detached from the holder at the mobile communication device, when the antenna is extended. The stopper element 2 has a cavity for receiving a resilient element 1.

The stopper further comprises a resilient element 1, only part of which is visible in this view. The resilient element 1 is embodied as a resilient bent strip. The resilient element 1 has a narrower upper portion, which when the resilient element 1 is mounted in the stopper element cavity, engages a corresponding portion of the cavity. The resilient element 1 has two legs extending downwards, which engage a corresponding portion of the stopper element cavity, and which prevents the resilient element 1 from falling out of the cavity.

In its unloaded position, i.e. when the stopper does not engage the holder, the resilient element 1 extends somewhat beyond the outer surface of the stopper, and the resilient element is compressed into the cavity when the stopper engages the holder. The lower portion of the cavity which engages the two legs is designed to allow the legs to bend inwards. The portion of the resilient element which extends beyond the outer surface of the stopper may also engage a corresponding recess in the holder, thus locking the antenna in its extended position.

FIG. 2 shows the first embodiment of the stopper in cross section, where the narrower upper portion 11, which is the first end of the resilient element 1, which engages a corresponding portion 21 of the cavity is visible. The lower portion 22, which is the second end of the stopper element cavity, which engage the lower ends 12 of the two legs of the resilient element is also visible. This area of the resilient element is the second end thereof.

FIG. 3 shows the first embodiment of the stopper, viewed from the side. Here the cavity side opening, through which the resilient element may be introduced into the stopper element is visible. The resilient element is here shown as a bent strip, but it may alternatively be embodied as a resilient wire, or it may be constituted as i.a. two identical bent wires or strips, attached to each other at the upper end, and having legs extending in orthogonal directions. A further alternative is a hollow or solid element made from plastic or some other resilient substance, shaped essentially like a ninepin, with a narrower upper portion for engaging the narrower upper portion 11 of the stopper element cavity.

FIG. 4 shows a first embodiment of a resilient element. The resilient element is easily manufactured by properly shaping a piece of strip of a width and thickness, which is chosen according to the resilient properties of the substance it is made of. If the resilient element acts as a connecting element, electrically connecting the antenna core to the RF transceiver of the mobile communication device, it is preferably made of metal, and electrically connected to the antenna core. The narrower upper portion 11 of the resilient element 1 may be electrically connected to the antenna core by resiliently pushing against the antenna core, or it may be soldered to the antenna core, or in any other way conductively joined with the core. Alternatively, the stopper element may act as the connecting element, in which case the resilient element may be constituted by a non conductive substance such as a plastic.

FIG. 5 shows the first embodiment of the stopper in cross section, while the resilient element is being inserted. The resilient element has been inserted into the cavity from the side opening of the cavity, and the upper portion 11 of the resilient element has been inserted into the corresponding portion 21 of the cavity. The legs are bent such that the lower ends 12 may be introduced into the lower portion 22 of the cavity, and once the force bending the legs is released, the legs move downwards in the direction indicated by the arrow. Once introduced into the cavity, the resilient element remains in the cavity by its own resiliency, and by the fact that the lower ends 12 are bent inward so that they are positioned more closely to each other than the mid portion of the resilient element. This way the resilient element will be locked inside the cavity through snap-action. Fig. 6 shows more clearly how the resilient element is introduced into the cavity from the side opening. Pressure is applied at the lower end of the legs 12 in the direction indicated by the lower arrow in order to longitudinally compress the resilient element, and its is the introduced into the cavity by moving its in the direction indicated by the upper arrow.

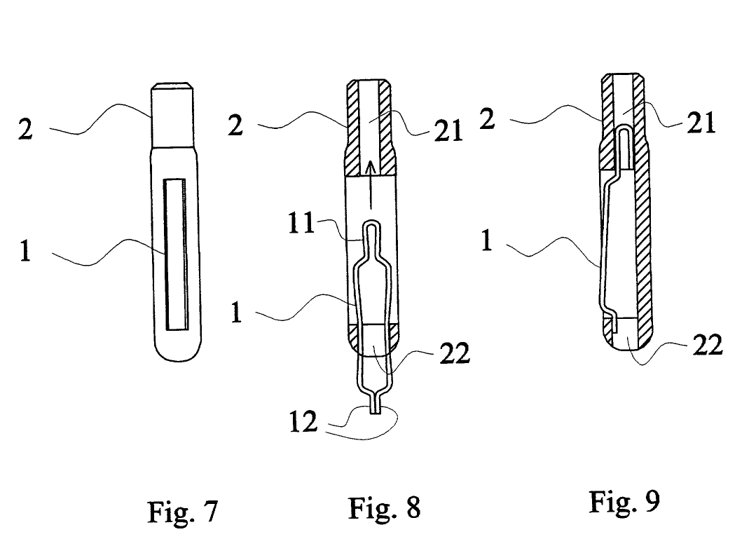

FIG. 7 shows a second embodiment of the stopper, viewed from the side. Here, the stopper element cavity has no side opening, through which the resilient element may be introduced. Instead, the resilient element is introduced through the lower opening 22 of the cavity, at the bottom end of the stopper element. This is show in cross section in FIG. 8. The resilient element has been resiliently compressed such that it may be introduced through the lower opening of the cavity, and pushed in the direction indicated by the arrow into its final position, where it will be snap-locked inside the cavity.

FIG. 9 shows a third embodiment of the stopper in cross section, where the resilient element is embodied with one leg only.

Although the invention has been described in conjunction with a number of preferred embodiments, it is to be understood that various modifications may still be made without departing from the scope of the invention as defined by the appended claims. For example, the resilient element may be a closed loop-like structure without separate legs.

1. A stopper for an extendable antenna which is mountable in a communication device, the stopper having a fastening portion for attachment to the lower end of an antenna rod, and being adapted to resiliently engage a holder when the antenna is extended, the stopper including a stopper element and a resilient element, characterised in that
the stopper element comprises a cavity, which at least partially encloses the resilient element.

2. The stopper according to claim 1, characterised in that
the resilient element is electrically conductive and connected to the antenna core, and
when the stopper element is engaging the holder, the resilient element engages a contact element in the holder, connecting the antenna core with a RF transceiver in the communication device.

3. The stopper according to claim 1, characterised in that
the stopper element is electrically conductive and connected to the antenna core, and
when the stopper element is engaging the holder, the stopper element engages a contact element in the holder, connecting the antenna core with a RF transceiver in the communication device.

4. The stopper according to one of claims 1-3, characterised in that the resilient element is comprised by a bent wire.

5. The stopper according to one of claims 1-4, characterised in that the resilient element is essentially U-shaped, having two legs.

6. The stopper according to one of claims 1-4, characterised in that the resilient element is essentially J-shaped, having one leg.

7. The stopper according to claim 5 or 6, characterised in that a first end of the stopper cavity is arranged for receiving a first end of the resilient element.

8. The stopper according to claim 7, characterised in that the first end of the stopper cavity is arranged for resiliently fixing the first end of the resilient element.

9. The stopper according to one of claim 7 or 8, characterised in that a second end of the stopper cavity is arranged for receiving a second end of the resilient element.

10. The stopper according to claim 9, characterised in that the second end of the stopper cavity is arranged to allow the second end of the resilient element to be resiliently offset towards the centre of the stopper.

11. The stopper according to claim 10, characterised in that the second end of the stopper cavity is arranged to receive the second end of the resilient element, and preventing the second end of the resilient element from being offset from the centre of the stopper further than the inner wall of the lower end of the stopper cavity.

12. The stopper according to one of claims 1-11, characterised in that the stopper element is provided with an opening through which the resilient element is introduceable into the cavity.

13. An antenna device including a stopper according to any one of the preceding claims.

14. A radio communication device including an antenna device according to claim 13.
